(19) United States
(12) Patent Application Publication
(10) Pub. No.: US 2024/0427200 A1
(43) Pub. Date: Dec. 26, 2024

(54) VIDEO DISPLAY DEVICE

(71) Applicant: Sharp Display Technology Corporation, Kameyama City (JP)

(72) Inventors: Takehisa YOSHIDA, Kameyama City (JP); Fumikazu SHIMOSHIKIRYOH, Kameyama City (JP); Shigeyuki YAMADA, Kameyama City (JP)

(21) Appl. No.: 18/668,387

(22) Filed: May 20, 2024

(30) Foreign Application Priority Data
Jun. 21, 2023 (JP) 2023-101788

(51) Int. Cl. G02F 1/1343; G02F 1/1335

(52) U.S. Cl. CPC G02F 1/13439; G02F 1/133601; G02F 1/134372

(57) ABSTRACT

Provided are a liquid crystal panel capable of controlling the viewing angle with less or no increase in thickness and a video display device including the liquid crystal panel. The video display device includes: a liquid crystal panel; and a display panel configured to display an image. The liquid crystal panel includes a first transparent substrate, a first electrode, a liquid crystal layer, a second electrode, an interlayer insulating film, a third electrode, and a second transparent substrate in the stated order. The liquid crystal layer includes an overlapping region overlapping the second electrode and a non-overlapping region not overlapping the second electrode, and thus includes a transparent region in a high transmission state and a switching region switchable between a high transmission state and a low transmission state. The liquid crystal layer is sandwiched between a pair of polarizing plates.

### CROSS-REFERENCE TO RELATED APPLICATIONS

The present application claims priority under 35 U.S.C. § 119 to Japanese Patent Application No. 2023-101788 filed on Jun. 21, 2023, the contents of which are incorporated herein by reference in their entirety.

### BACKGROUND OF THE INVENTION

### Field of the Invention

The following disclosure relates to video display devices.

### Description of Related Art

Video display devices including a display panel such as a liquid crystal panel are widely used in various devices such as televisions, mobile phones, and PC displays. Studies to enhance the viewing angle characteristics of such video display devices have been made such that images can be observed at similar levels regardless of whether the images are observed in a narrow viewing angle range or a wide viewing angle range. Meanwhile, in terms of privacy protection, a display method has been considered that allows observation of images in a narrow viewing angle range but makes the images difficult to observe in a wide viewing angle range. Such studies and consideration suggest a desire for display devices capable of switching between a public mode (wide viewing angle mode) that allows observation of images at similar levels in a narrow viewing angle range and a wide viewing angle range and a privacy mode (narrow viewing angle mode) that allows observation of images in the narrow viewing angle range but makes the images difficult to observe in the wide viewing angle range.

Techniques to switch between viewing angle modes have been disclosed. For example, JP 2007-206373 A discloses an optical element including, between a pair of transparent substrates, first regions made of a light-transmissive material and a second region placed between the first regions and containing a liquid crystal material selectively switchable between a light transmission state and a scattering or absorptive state. JP 2005-221756 A discloses a viewing angle control element including first regions having a first transmittance and second regions capable of switching between a second transmittance and a third transmittance which is less than the first transmittances, each of the first and second regions being positioned opposite to one of pixels.

JP 2007-178907 A discloses a technique of generating a longitudinal electric field in a liquid crystal display device having an FFS structure, in which a horizontal electric field is generated between a pair of electrodes placed on one of a pair of substrates, by further providing an electrode on the other of the pair of substrates, i.e., the counter substrate. JP 2021-67852 A discloses a technique in which in a liquid crystal panel including an active matrix substrate, a liquid crystal layer, and a color filter substrate, the active matrix substrate having an FFS electrode structure including a first electrode and second electrodes stacked with an insulating layer in between on a first substrate, a third electrode is further placed on the color filter substrate with the third electrode not overlapping at least a portion of each of the optical openings in the sub-pixels.

### BRIEF SUMMARY OF THE INVENTION

FIG. 13A is a schematic cross-sectional view showing a wide viewing angle mode of a video display device 1R of a comparative embodiment. FIG. 13B is a schematic cross-sectional view showing a narrow viewing angle mode of the video display device 1R of the comparative embodiment. The video display device 1R shown in FIG. 13A and FIG. 13B includes, sequentially from the observation surface side toward the back surface side, a display panel 10, a liquid crystal panel 20R including a polymer dispersed liquid crystal (PDLC), a louver layer 30R, and a backlight 40.

The display panel 10 includes, sequentially from the observation surface side toward the back surface side, a color filter (CF) substrate 110 including a CF layer, and a thin-film transistor (TFT) substrate 120 including TFTs.

The liquid crystal panel 20R includes, between a pair of transparent substrates 210 and 220, a pair of electrodes 230 and a liquid crystal layer 240R made of PDLC and sandwiched between the electrodes. PDLC has a structure in which liquid crystal components are dispersed in a polymer network. As shown in FIG. 13A and FIG. 13B, the liquid crystal panel 20R can switch between a transmission state and scattering state using the refractive index difference between the liquid crystal components and the polymer network caused by changing the alignment state of the liquid crystal components through application of voltage to the liquid crystal layer 240R. When a type of PDLC that scatters light in a state with no voltage applied is used, the liquid crystal panel 20R is switched to a scattering state during no voltage application and to a transmission state during voltage application.

The louver layer 30R has a configuration in which light blocking portions 31 mainly made of a light-absorbing material and transparent portions 32 mainly made of a transparent resin are alternately arranged in parallel. The louver layer 30R has a function of transmitting light 1LA traveling in a front direction from the backlight 40 and blocking light 1LB traveling in an oblique direction from the backlight 40. In other words, the louver layer 30R has a function of transmitting light at a low polar angle and blocking light at a high polar angle.

In the video display device 1R in both the wide viewing angle mode and the narrow viewing angle mode, the light 1LB traveling in an oblique direction from the backlight 40 is blocked (cut) by the louver layer 30R, and only the light 1LA traveling in a front direction from the backlight 40 is transmitted through the louver layer 30R (see FIG. 13A and FIG. 13B). During no voltage application, the light 1LA traveling in a front direction transmitted through the louver layer 30R is then scattered (attenuated) in the liquid crystal panel 20R to spread and then enter the display panel 10 (see FIG. 13A). During voltage application, the light 1LA traveling in a front direction transmitted through the louver layer 30R is then transmitted through the liquid crystal panel 20R without being scattered to enter the display panel 10 (see FIG. 13B).

The video display device 1R during no voltage application thus achieves the wide viewing angle mode by transmitting backlight illumination in a region ranging from low to high polar angles. Meanwhile, the video display device 1R during voltage application achieves the narrow viewing angle mode by transmitting the backlight illumination only at low polar angles without transmitting the backlight illumination at high polar angles. The video display device 1R, however, disadvantageously has an increased thickness because the liquid crystal panel 20R and the louver layer 30R are added as separate components to the display panel 10 in order to switch between the wide viewing angle mode and the narrow viewing angle mode.

In the optical element disclosed in JP 2007-206373 A, the first regions in the light transmission state and the second region selectively switchable between the light transmission state and the scattering or absorptive state are physically differentiated by using different materials for the regions. Such an optical element has various challenges to overcome for practical implementation, including difficulty in narrowing the viewing angle through an ordinary liquid crystal process and complexity of the manufacturing process.

For example, JP 2007-206373 A states that a UV photosensitive resin is preferred as the light-transmissive material used to form the first regions. When a UV photosensitive resin is used, the resulting resin layer has an increased thickness. In this respect, JP 2007-206373 A shows an example in which a composite material used to form the second region to achieve a narrow viewing angle) (60° is patterned to a height of 300 μm, with the widths ranging from 10 to 30 μm and a pitch of 200 μm. The thickness of the light-transmissive material used to form the first regions corresponds to the height in this patterning example. A height of 300 μm, however, is difficult to achieve through an ordinary liquid crystal process (which commonly gives a height within 10 μm). Thus, when a UV photosensitive resin is used as the light-transmissive material, the viewing angle is difficult to narrow. Examples of the light-transmissive material also include polymer materials including liquid crystal molecules, specifically UV-curable composite materials in which liquid crystal molecules are dispersed in a UV-curable polymer. In this case, a process of applying voltage for UV curing as shown in FIG. 11 in JP 2007-206373 A is required to switch the first regions to the light transmission state. This complicates the process of manufacturing an optical element.

The viewing angle control element disclosed in JP 2005-221756 A, for example, includes the first regions made of a columnar transmissive resin layer and the second regions made of a liquid crystal layer. In this case, common photolithography can be used to form a fine pattern of a columnar light-transmissive resin layer with high dimensional accuracy, so that the viewing angle control element can be manufactured without a change in the existing liquid crystal manufacturing process. The viewing angle control element thus can prevent degradation of image quality due to a decrease in luminance of the video display element in the wide viewing angle state while achieving both the wide viewing angle and the narrow viewing angle, being significantly useful in the field of display devices. However, the viewing angle control element still leaves room for improvement in further simplifying the manufacturing process and further facilitating the viewing angle control.

The techniques disclosed in JP 2007-178907 A and JP 2021-67852 A are intended to control the viewing angle using a substrate having the FFS structure and the counter electrode placed on its counter substrate in the display liquid crystal (panel) that displays images. In particular, the technique disclosed in JP 2021-67852 A is very useful because it can be combined with the soft-veil view function and enables a display device having a high transmittance and a high contrast ratio while ensuring privacy by making images on the liquid crystal panel unviewable from the left-right directions and oblique directions. These techniques, however, leave room for improvement in allowing control of the viewing angle with any configuration of the display liquid crystal (panel) that displays images.

In response to the above issues, an object of the present invention is to provide a liquid crystal panel capable of controlling the viewing angle with less or no increase in thickness and a video display device including the liquid crystal panel.
(1) One embodiment of the present invention is directed to a video display device including: a liquid crystal panel; and a display panel configured to display an image, the liquid crystal panel including a first transparent substrate, a first electrode, a liquid crystal layer, a second electrode, an interlayer insulating film, a third electrode, and a second transparent substrate in the stated order, the liquid crystal layer including an overlapping region overlapping the second electrode and a non-overlapping region not overlapping the second electrode, and thus including a transparent region in a high transmission state and a switching region switchable between a high transmission state and a low transmission state, the liquid crystal layer being sandwiched between a pair of polarizing plates.
(2) In an embodiment of the present invention, the video display device includes the structure (1), and the video display device is capable of applying different voltages to the transparent region and the switching region, respectively.
(3) In an embodiment of the present invention, the video display device includes the structure (1) or (2), a thickness of the non-overlapping region is 30 μm or smaller.
(4) In an embodiment of the present invention, the video display device includes the structure (1), (2), or (3), and the second electrode is a transparent electrode or an electrode containing a light-absorbing material.
(5) In an embodiment of the present invention, the video display device includes the structure (1), (2), (3), or (4), and further includes a backlight.
(6) In an embodiment of the present invention, the video display device includes the structure (5), and the backlight has a local dimming function.
(7) In an embodiment of the present invention, the video display device includes the structure (1), (2), (3), (4), (5), or (6), and the display panel is a liquid crystal display panel or a self-luminous display panel.

The present invention can provide a liquid crystal panel capable of controlling the viewing angle with less or no increase in thickness and a video display device including the liquid crystal panel.

### BRIEF DESCRIPTION OF THE DRAWINGS

FIG. 1 is a schematic cross-sectional view of a video display device of Embodiment 1.

FIG. 2A is a schematic cross-sectional view showing a wide viewing angle mode of the video display device of Embodiment 1.

FIG. 2B is a schematic cross-sectional view showing a narrow viewing angle mode of the video display device of Embodiment 1.

FIG. 3 is a conceptual diagram showing a thickness D of a non-overlapping region, a width W1 of the non-overlapping region, a width W2 of an overlapping region, and a viewing angle θ.

FIG. 4 is a schematic cross-sectional view of a video display device of a modified example of Embodiment 1.

FIG. 5 is a schematic plan view showing the arrangement of second electrodes in a liquid crystal panel in the video display device of Embodiment 1.

FIG. 6 is a schematic cross-sectional view of a video display device of Embodiment 2.

FIG. 7A is a schematic cross-sectional view of a video display device of Embodiment 3.

FIG. 7B is a schematic cross-sectional view of a video display device of a modified example of Embodiment 3.

FIG. 8A is a schematic cross-sectional view showing a wide viewing angle mode of a video display device of Embodiment 4.

FIG. 8B is a schematic cross-sectional view showing a narrow viewing angle mode of the video display device of Embodiment 4.

FIG. 9A is a schematic cross-sectional view showing a wide viewing angle mode of a video display device of Embodiment 5.

FIG. 9B is a schematic cross-sectional view showing a narrow viewing angle mode of the video display device of Embodiment 5.

FIG. 10 is a schematic cross-sectional view of a video display device of Embodiment 7.

FIG. 11A is a schematic cross-sectional view showing a wide viewing angle mode of a video display device of Example 1.

FIG. 11B is a schematic cross-sectional view showing a narrow viewing angle mode of the video display device of Example 1.

FIG. 12A shows waveform diagrams of voltages of electrodes in the wide viewing angle mode in the video display device of Example 1.

FIG. 12B shows waveform diagrams of voltages of electrodes in the narrow viewing angle mode in the video display device of Example 1.

FIG. 13A is a schematic cross-sectional view showing a wide viewing angle mode of a video display device of a comparative embodiment.

FIG. 13B is a schematic cross-sectional view showing a narrow viewing angle mode of the video display device of the comparative embodiment.

### DETAILED DESCRIPTION OF THE INVENTION

### Definition of Terms

The “observation surface side” herein means the side closer to the screen (display surface) of the video display device. The “back surface side” herein means the side farther from the screen (display surface) of the video display device.

The “polar angle” herein means an angle formed by the direction in question (e.g., measurement direction) and the direction normal to the panel surface of the liquid crystal panel.

An “azimuth (q)” herein means the direction in question in a view projected onto the screen of the liquid crystal panel and is expressed as an angle (azimuthal angle) formed with the reference azimuth.

The reference azimuth (q=) 0° is set to the right in the horizontal direction of the screen of the liquid crystal panel. The angle and azimuthal angle measure positive in the counterclockwise direction from the reference azimuth and measure negative in the clockwise direction from the reference azimuth. Both the counterclockwise and clockwise directions are rotational directions when the screen of the liquid crystal panel is viewed from the observation surface side (front). The angle is a value measured in a plan view of the screen of the liquid crystal panel.

The expression of being “parallel” to each other means that they form an angle (absolute value) within the range of 0°±3°, preferably within the range of 0°±1°, more preferably within the range of 0°±0.5°, particularly preferably 0° (completely parallel).

A state with no voltage applied means a state where the voltage applied to the liquid crystal layer is lower than the threshold voltage (including no voltage application). A state with voltage applied means a state where the voltage applied to the liquid crystal layer is equal to or higher than the threshold voltage. Herein, the state with no voltage applied is also referred to as “during no voltage application”, and the state with voltage applied is also referred to as “during voltage application”.

A light transmittance of a sample was calculated by separately measuring the luminance of an LED backlight and the luminance of the LED backlight with the sample placed thereon, and normalizing with the measured luminance of the LED backlight. The measurements were performed with a spectrophotometer “SR-UL1” available from Topcon Corporation. A light reflectance was measured with a spectrophotometer CM-2600d (measurement wavelength range: 360 nm to 740 nm, integrating sphere method) available from Konica Minolta, Inc.

Hereinbelow, embodiments of the present invention are described. The present invention is not limited to the contents of the following embodiments. The design may be appropriately modified within the range satisfying the configuration of the present invention.

### Embodiment 1

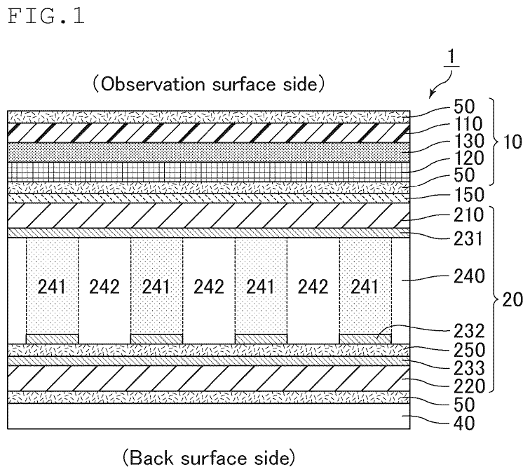

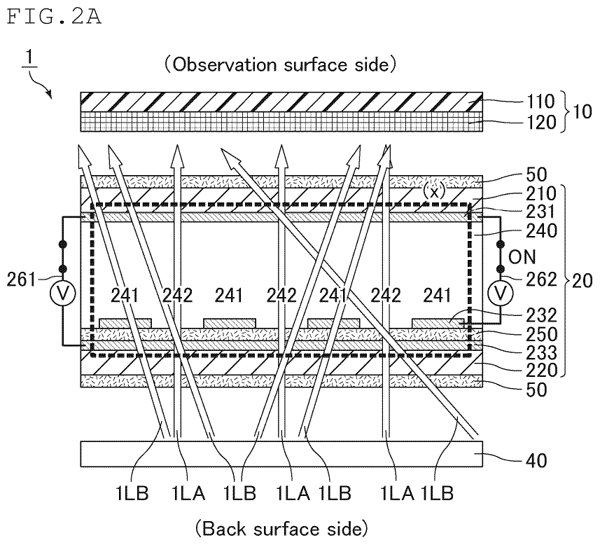

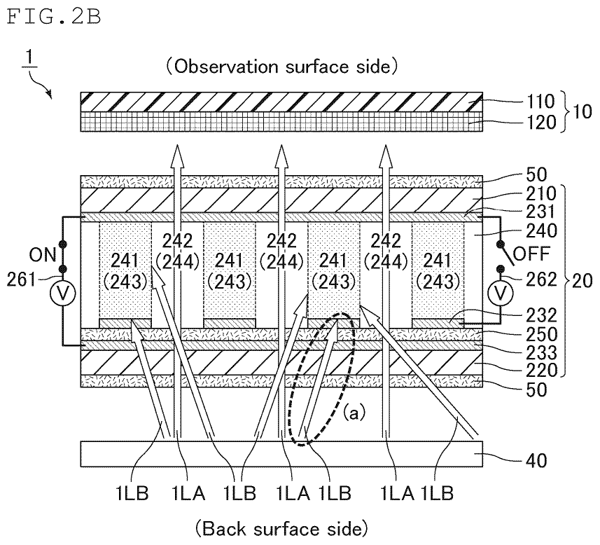

FIG. 1 is a schematic cross-sectional view of a video display device of the present embodiment. FIG. 2A is a schematic cross-sectional view showing a wide viewing angle mode of the video display device of the present embodiment. FIG. 2B is a schematic cross-sectional view showing a narrow viewing angle mode of the video display device of the present embodiment.

As shown in FIG. 1, FIG. 2A, and FIG. 2B, a video display device 1 of the present embodiment includes a liquid crystal panel 20 and a display panel 10 that displays images. This enables a video display device that can control the viewing angle with less or no increase in thickness. The video display device 1 of the present embodiment further includes a backlight 40. In the present embodiment, a video display device can be achieved that can display images on the display panel 10 using light from the backlight 40 and can control the viewing angle with less or no increase in thickness.

### <Liquid Crystal Panel>

The liquid crystal panel 20 includes a first transparent substrate 210, a first electrode 231, a liquid crystal layer 240, second electrodes 232, and a second transparent substrate 220 in the stated order. The liquid crystal panel 20 further includes, between the second electrodes 232 and the second transparent substrate 220, an interlayer insulating film 250 and a third electrode 233 in the stated order from the second electrode 232 side. The liquid crystal panel 20, which has a function of controlling the viewing angle, can also be referred to as a “viewing angle control cell”.

The liquid crystal panel 20 is provided with a pair of polarizing plates 50, one on its back surface side and the other on its observation surface side. This results in a structure (i.e., sandwiched structure) in which the liquid crystal layer 240 is sandwiched between the pair of polarizing plates 50. FIG. 2A and FIG. 2B each show the polarizing plates 50 respectively placed on the back surface side and the observation surface side of the liquid crystal panel 20. Here, one of these polarizing plates 50 placed adjacent to the display panel 10 can also be defined by the polarizing plate in the display panel 10 (see FIG. 1).

The liquid crystal layer 240 includes overlapping regions 241 each overlapping a second electrode 232 and non-overlapping regions 242 not overlapping a second electrode 232. The liquid crystal layer 240 is sandwiched between the pair of polarizing plates 50 as described above. In this configuration, the liquid crystal layer 240 includes transparent regions 244 in a high transmission state and switching regions 243 switchable between a high transmission state and a low transmission state. Depending on the design of the power supply, the overlapping regions 241 can be set as the switching regions 243 while the non-overlapping regions 242 can be set as the transparent regions 244, or the overlapping regions 241 can be set as the transparent regions 244 while the non-overlapping regions 242 can be set as the switching regions 243. The present embodiment is designed to switch the switching regions 243 between the high transmission state and the low transmission state depending on whether voltage is applied or not applied between the first electrode 231 and the second electrodes 232 (262), so that the overlapping regions 241 serve as the switching regions 243 and the non-overlapping regions 242 serve as the transparent regions 244 (see FIG. 1, FIG. 2A, and FIG. 2B). In practice, not only the overlapping regions 241 serve as the switching regions 243 but also the boundary between an overlapping region 241 and a non-overlapping region 242 may serve as a switching region 243 or a different portion may serve as a switching region 243, depending on the intensity of the electric field generated between the electrodes.

The key point of the present invention is that the liquid crystal layer 240 sandwiched between the pair of polarizing plates 50 includes the overlapping regions 241 each overlapping a second electrode 232 and the non-overlapping regions 242 not overlapping a second electrode 232, and thus includes the transparent regions 244 in a high transmission state and the switching regions 243 switchable between a high transmission state and a low transmission state. In other words, the key feature of the present invention is that regions in a high transmission state and regions in a low transmission state are formed in the liquid crystal layer 240 in response to voltage application or no voltage application to the electrodes, so that the liquid crystal layer 240 itself can act as an on-off switchable louver. The high transmission state and the low transmission state are regulated by changing or maintaining the alignment (i.e., retardation) of liquid crystal molecules in the liquid crystal layer 240 controlled by voltage application to change the polarization state of light transmitted through one of the pair of polarizing plates 50 between which the liquid crystal layer 240 is sandwiched. In other words, depending on whether the alignment of the liquid crystal molecules is changed or maintained, the polarization state of the light is switched to the state allowing the light to be transmitted through the other of the pair of polarizing plates 50 or to the state causing the light to be blocked by the other of the pair of polarizing plates 50. This is how the high transmission state and the low transmission state are regulated.

Thus, the positions of the transparent regions 244 and the switching regions 243 and regions corresponding to the transparent regions 244 and the switching regions 243 are not limited. In other words, the transparent regions 244 and the switching regions 243 are not limited to the modes shown in FIG. 1, FIG. 2A, and FIG. 2B, and can appropriately be controlled by, for example, the width and pitch of the second electrodes 232, the cell thickness (i.e., thickness D of the non-overlapping regions 242), and voltage applied to the electrodes.

In the present embodiment, the second electrodes 232 and the third electrode 233 are placed with the interlayer insulating film 250 in between. In this case, the first electrode 231 can function as a common electrode, the first electrode 231 and the third electrode 233 can control voltage application or no voltage application to the non-overlapping regions 242 (transparent regions 244), and the first electrode 231 and the second electrodes 232 can control voltage application or no voltage application to the overlapping regions 241 (switching regions 243). Thus, in the present embodiment, different voltages can be applied to a transparent region 244 and a switching region 243, respectively. Such an electrode structure is very useful as being compatible with various driving methods in the field of video display devices.

The transparent regions 244 are in a high transmission state when voltage is applied between the first electrode 231 and the third electrode 233 (261). The high transmission state is a state where the transparency to light is high; specifically, the transmittance is T1 or T2.

The switching regions 243 are switchable between a high transmission state and a low transmission state. In other words, these are regions switchable between a first state with high transparency to light and a second state with lower transparency than the first state. Specifically, the high transmission state is a state with a transmittance T1, and the low transmission state is a state with a transmittance T3. Here, T1, T2, and T3 satisfy the relationship “T1≥T2>T3”. The liquid crystal layer 240 in the low transmission state, for example, is in a state similar to light blocking glass.

In the present embodiment, as described later, in the wide viewing angle mode (see FIG. 2A), the transparent regions 244 and the switching regions 243 have a certain transmittance (also referred to as a visible light transmittance or light transmittance) T1. In the narrow viewing angle mode (see FIG. 2B), the transparent regions 244 have a transmittance T2 and the switching regions 243 have a transmittance T3. Here, T1, T2, and T3 satisfy the relationship “T1≥T2>T3”. The transmittance T1 may be 100%. T3 may be 0%.

As shown in FIG. 2A and FIG. 2B, light from the back surface side (specifically, backlight 40) enters the liquid crystal panel 20. In the state where voltage is applied between the first electrode 231 and the second electrodes 232 (262) and voltage is applied between the first electrode 231 and the third electrode 233 (261) (the state with voltage applied), the overlapping regions 241 and the non-overlapping regions 242 are integrated without distinction, and thus the entire liquid crystal layer 240 is in the high transmission state (i.e., constitutes a transparent region) (see FIG. 2A). In other words, the transparent regions 244 and the switching regions 243 have a transmittance T1. In this case, light traveling in a front direction and light traveling in an oblique direction, both emitted from the backlight 40 and having entered the liquid crystal panel 20, are transmitted through the liquid crystal panel 20 as they are (see FIG. 2A). As a result, in a region ranging from low to high polar angles, light from the back surface side (specifically, backlight 40) can be transmitted without any loss, so that the wide viewing angle mode can be achieved with high luminance.

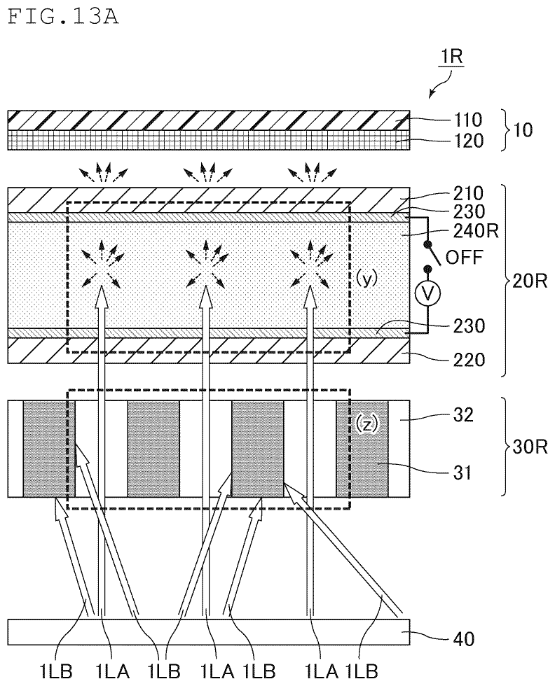

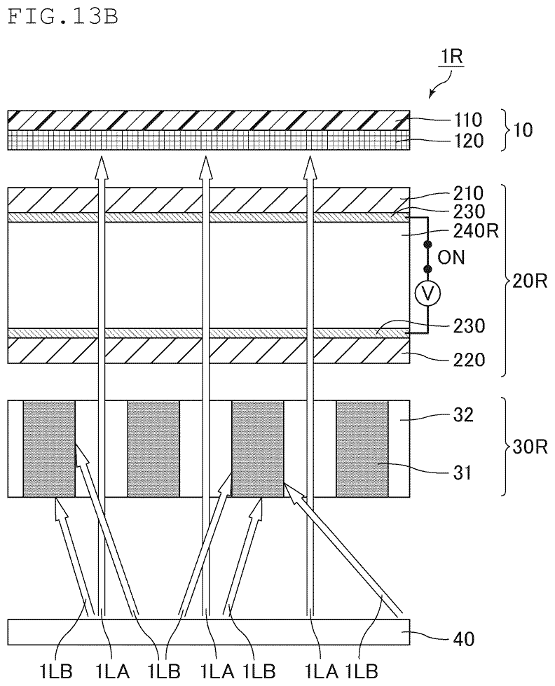

In the video display device 1R of the comparative embodiment in the wide viewing angle mode, the louver layer 30R unnecessarily cuts the light 1LB traveling in an oblique direction (see the portion (z) in FIG. 13A). In addition, the light narrowed down by the louver layer 30R is scattered (attenuated) in the PDLC layer 240R to be spread again (see the portion (y) in FIG. 13A). This causes transmission loss through both the louver layer 30R and the PDLC layer 240R, leading to insufficient luminance in the wide viewing angle mode. In contrast, the liquid crystal panel 20 of the present embodiment can transmit light from the backlight 40 without any loss as described above, achieving the wide viewing angle mode with high luminance.

In the present embodiment, in the state where no voltage is applied between the first electrode 231 and the second electrodes 232 (262) and voltage is applied between the first electrode 231 and the third electrode 233 (261) (the state with no voltage applied), the liquid crystal layer 240 itself acts as a louver. In other words, the light 1LB traveling in an oblique direction, emitted from the backlight 40 and having entered the liquid crystal layer 240, is blocked by the overlapping regions 241 (switching regions 243). For this reason, the overlapping regions 241 (switching regions 243) are in the low transmission state, whereas the non-overlapping regions 242 (transparent regions 244) remain in the high transmission state. In other words, the transparent regions 244 have a transmittance T2 and the switching regions 243 have a transmittance T3 (here, T1>T2>T3). The light 1LA traveling in a front direction, emitted from the backlight 40 and having entered the liquid crystal layer 240, is transmitted through the liquid crystal panel 20 without attenuation (see FIG. 2B). As a result, light from the back surface side (specifically, backlight 40) is attenuated at high polar angles, while the light from the back surface side can be transmitted with the same luminance only at low polar angles, so that the narrow viewing angle mode can be achieved.

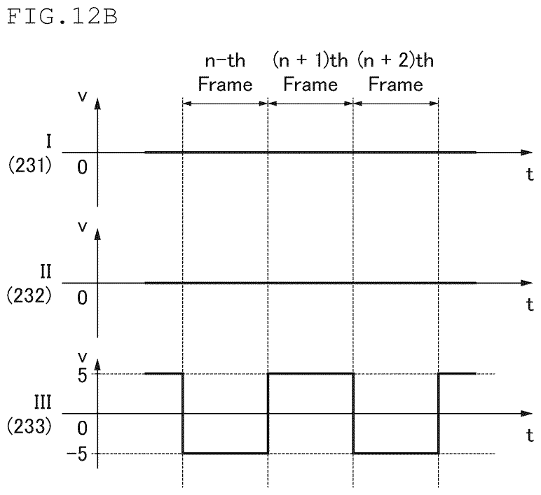

As described above, the liquid crystal panel 20 has a function of controlling the viewing angle in response to voltage application or no voltage application, and additionally has a louver function in combination. Thus, as compared to the video display device 1R of the comparative embodiment separately including the liquid crystal panel 20R and the louver layer 30R (see FIG. 12A and FIG. 12B), the video display device of the present embodiment can also reduce or prevent an increase in thickness, weight, and manufacturing cost.

The overlapping regions 241 are regions of the liquid crystal layer 240 each overlapping a second electrode 232. The expression “overlapping a second electrode 232” means that it is in direct or indirect contact with the second electrode 232. A mode where an overlapping region 241 is in indirect contact with a second electrode 232 may be, for example, a mode where the overlapping region 241 and the second electrode 232 are in contact with each other via an alignment film. The alignment film is a film having a function of controlling the alignment of liquid crystal molecules in the liquid crystal layer 240. The non-overlapping regions 242 are regions of the liquid crystal layer 240 not overlapping a second electrode 232.

The thickness D of the non-overlapping regions 242 is, for example, preferably 100 μm or smaller, more preferably 50 μm or smaller, still more preferably 30 μm or smaller, particularly preferably 20 μm or smaller, most preferably 10 μm or smaller. Thus, the liquid crystal panel 20 in the video display device 1 of the present embodiment is compatible with an ordinary liquid crystal process (which commonly gives a height within 10 μm) and exhibits excellent viewing angle performance. The lower limit of the thickness is not limited, and is preferably 1 μm or greater, for example.

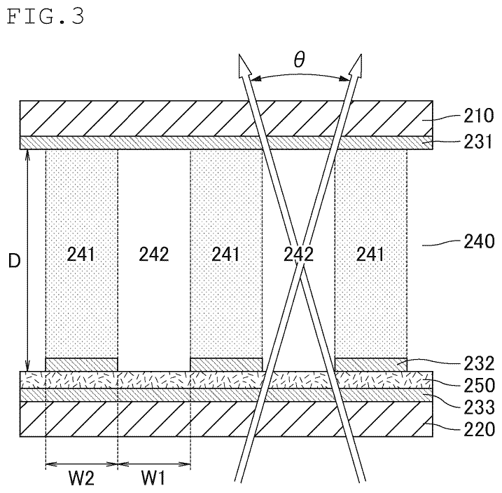

The thickness of the non-overlapping regions 242 is also referred to as the height of the non-overlapping regions 242. The thickness of the non-overlapping regions 242 corresponds to the distance D between the first electrode 231 and the interlayer insulating film 250 in FIG. 3.

The pitch of the non-overlapping regions 242 is suitably smaller than the pixel pitch of the display panel 10. This can sufficiently reduce or prevent generation of moire. In particular, the pixel pitch of the display panel 10 is suitably an integer multiple of the pitch of the non-overlapping regions 242. The pixel pitch is more preferably 1 to 50 times, still more preferably 6 to 24 times, the pitch of the non-overlapping regions.

The width W1 of the non-overlapping regions 242 and the width W2 of the overlapping regions 241 can be set as appropriate according to the desired viewing angle. For example, the width ratio (W1/W2) may be from 100/1 to 100/500, or from 100/50 to 100/300.

The viewing angle θ of the liquid crystal panel 20 in the narrow viewing angle mode can be set as desired depending on the thickness D and the width W1 of the non-overlapping regions 242. Specifically, the viewing angle θ can be set according to the following formula (1).

θ=2 tan⁻¹(W1/D) (1)

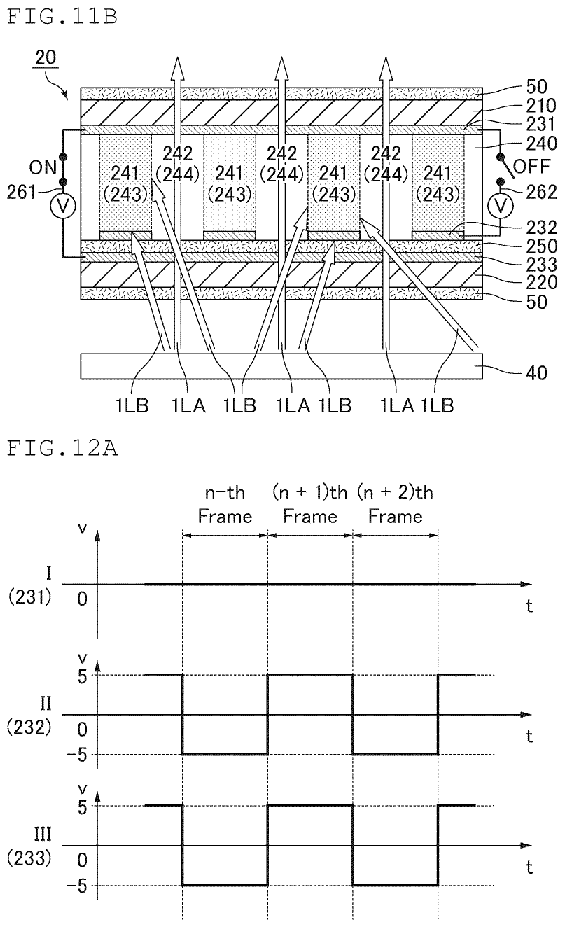

Since the liquid crystal panel 20 is compatible with the ordinary liquid crystal process (which commonly gives a height within 10 μm) as described above, the video display device of the present embodiment can easily achieve the narrow viewing angle mode and has excellent viewing angle performance. In the present embodiment, distinction is made between the transparent regions 244 and the switching regions 243 not physically by their materials but by their power supply designs (e.g., electrode arrangement). The transparent regions 244 and the switching regions 243 are made of the same material. The present embodiment thus eliminates the need for the UV curing process for presetting the transparent regions to the transmission state during manufacturing as shown in FIG. 11 in JP 2007-206373 A, for example. The video display device 1 of the present embodiment is advantageous in terms of simplification of the manufacturing process as well. The following further describes the liquid crystal panel 20.

The first transparent substrate 210 and the second transparent substrate 220 may each be any substrate transparent to visible light. Examples include glass substrates and plastic substrates.

The first electrode 231 is a planar electrode placed on the entire surface of the first transparent substrate 210. In other words, the first electrode 231 is a solid electrode covering the first transparent substrate 210. This allows switching between the wide viewing angle mode and the narrow viewing angle mode across the entire liquid crystal panel. The first electrode 231 may be a transparent electrode. The transparent electrode can be made of, for example, a transparent conductive material such as indium tin oxide (ITO), indium zinc oxide (IZO), zinc oxide (ZnO), or tin oxide (SnO), or an alloy of any of these materials.

The second electrodes 232 are spaced from each other such that the liquid crystal layer 240 can be separated into the overlapping regions 241 each overlapping a second electrode and the non-overlapping regions 242 not overlapping a second electrode. In the present embodiment, as shown in FIG. 5, the second electrodes 232 are arranged in a stripe pattern (slit pattern) in a plan view. With this arrangement, the viewing angle in the left-right directions of the screen can be controlled. The second electrodes 232 in the present embodiment are transparent electrodes. Examples of the transparent electrodes are as described above.

The third electrode 233 in the present embodiment is a planar electrode placed on the entire surface of the second transparent substrate 220. In other words, the third electrode 233 is a solid electrode covering the second transparent substrate 220. The third electrode 233 may be a transparent electrode. Examples of the transparent electrode are as described above.

The liquid crystal layer 240 is composed of a liquid crystal composition containing liquid crystal molecules. For example, the liquid crystal molecules (also referred to as liquid crystal components) are preferably nematic liquid crystal molecules. The anisotropy of dielectric constant (Δε) defined by the following formula (L):

Δε=(dielectric constant in long axis direction of liquid crystal components)−(dielectric constant in short axis direction of liquid crystal components) (L)

may be positive or negative. Liquid crystal molecules having positive anisotropy of dielectric constant are aligned parallel to the electric field direction, while liquid crystal molecules having negative anisotropy of dielectric constant are aligned vertically to the electric field direction. The liquid crystal molecules having positive anisotropy of dielectric constant are also referred to as a positive liquid crystal (or positive liquid crystal molecules). Liquid crystal molecules having negative anisotropy of dielectric constant are also referred to as a negative liquid crystal (or negative liquid crystal molecules).

In the present embodiment, the liquid crystal molecules are particularly preferably negative liquid crystal molecules. Also suitable are those homeotropically aligned in a state where voltage is not applied (the state with no voltage applied). The direction of the long axes of liquid crystal molecules in the state with no voltage applied is also referred to as the initial alignment direction of the liquid crystal molecules.

The interlayer insulating film 250 can be an organic insulating film, an inorganic insulating film, or a stack of an organic insulating film and an inorganic insulating film. The organic insulating film can be, for example, an organic film (relative dielectric constant ε=2 to 5) such as an acrylic resin film, a polyimide resin film, or a novolac resin film, or a stack of any of these films. The film thickness of the organic insulating film is not limited and may be, for example, 2 μm or greater and 4 μm or smaller. The inorganic insulating film can be, for example, an inorganic film (relative dielectric constant ε=5 to 7) such as a silicon nitride (SiNx) film or a silicon oxide (SiO₂) film or a stack of any of these films. The film thickness of the inorganic insulating film is not limited and may be, for example, 1500 Å or greater and 3500 Å or smaller.

The film thickness of the interlayer insulating film 250 is preferably 0.1 μm or greater and 4 μm or smaller, more preferably 0.15 μm or greater and 0.35 μm or smaller.

### <Polarizing Plate>

As described above, the liquid crystal layer 240 is sandwiched between the pair of polarizing plates 50. The polarizing plates 50 may be circularly polarizing plates or linearly polarizing plates. A linearly polarizing plate means a polarizing plate having a function of letting only polarized light (linearly polarized light) vibrating in a specific direction pass therethrough when unpolarized light (natural light), partially polarized light, or polarized light is incident thereon. The linearly polarizing plate is distinguished from a circularly polarizing plate. In particular, the polarizing plates 50 are preferably linearly polarizing plates.

The polarizing plates 50 may also be absorptive polarizing plates or reflective polarizing plates. An absorptive polarizing plate is a polarizing plate having a function of absorbing light vibrating in a specific direction and transmitting polarized light (linearly polarized light) vibrating in a direction perpendicular to the specific direction. A reflective polarizing plate is a polarizing plate having a function of reflecting light vibrating in a specific direction and transmitting polarized light (linearly polarized light) vibrating in a direction perpendicular to the specific direction. In particular, the polarizing plates 50 are preferably absorptive polarizing plates. Particularly suitable are absorptive linearly polarizing plates.

The pair of polarizing plates 50 between which the liquid crystal layer 240 is sandwiched may be arranged, for example, in crossed Nicols or parallel Nicols, and are suitably arranged in crossed Nicols.

### <Display Panel>

The display panel 10 may be any display panel having a function of displaying images. As described above, since the video display device 1 of the present embodiment has a function of controlling the viewing angle of the liquid crystal panel 20, the display panel 10 needs not to be imparted with the function of controlling the viewing angle. Thus, the structure, the driving mode, and other properties of the display panel 10 are not limited, so that the design flexibility of the display panel 10 increases.

The image display of the display panel 10 can be turned on or off. The present embodiment is described based on an example in which the display panel 10 is a liquid crystal display panel.

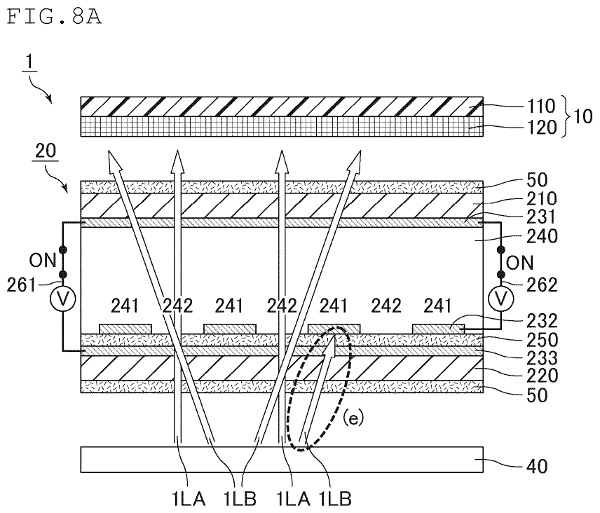

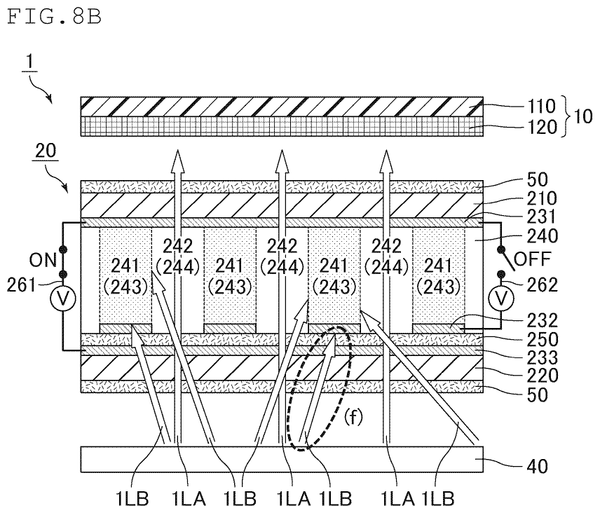

The display panel 10 includes, as shown in FIG. 1, a polarizing plate 50, a color filter (CF) substrate 110 including a CF layer, a liquid crystal layer 130, a thin-film transistor (TFT) substrate 120 including TFTs, and a polarizing plate 50 in order from the observation surface side toward the back surface side. An adhesive layer 150 is usually placed between the display panel 10 and the liquid crystal panel 20 to attach the display panel 10 and the liquid crystal panel 20 to each other. As described above, the polarizing plate 50 on the liquid crystal panel 20 side of the pair of polarizing plates 50 included in the display panel 10, when appropriate, can be used as a substitute for one of the pair of polarizing plates 50 between which the liquid crystal layer 240 is sandwiched in the liquid crystal panel 20. In other words, the display panel 10 and the liquid crystal panel 20 can share a polarizing plate, with no need to make each of the display panel 10 and the liquid crystal panel 20 have a pair of polarizing plates. In the present embodiment, since the display panel 10 functions as a liquid crystal display panel, the video display device of the present embodiment is a liquid crystal display device. In FIG. 2A and FIG. 2B (as well as FIG. 8A to FIG. 12B described below), the display panel 10 does not include the liquid crystal layer 130, but may include the liquid crystal layer 130 as in FIG. 1.

The TFT substrate 120 includes an insulating substrate and, in the display region on the insulating substrate, parallel gate lines and parallel source lines extending in a direction intersecting the gate lines via an insulating film. The gate lines and the source lines as a whole are formed in a grid pattern to define the pixels. Thin-film transistors as switching elements are placed at the intersections of the source lines and the gate lines.

The TFT substrate 120 includes a planar common electrode placed on the liquid crystal layer 130 side surface of the insulating substrate, an insulating film covering the common electrode, and pixel electrodes placed on the liquid crystal layer side surface of the insulating film and provided with slits. The pixel electrodes are placed in the respective regions each surrounded by adjacent two source lines and adjacent two gate lines. Each pixel electrode is electrically connected to the corresponding source line via the semiconductor layer in the corresponding thin-film transistor. In other words, the display panel 10 in the present embodiment is a fringe field switching (FFS) mode liquid crystal display panel. The positions of the common electrode and the pixel electrodes may be switched. In this case, a common electrode provided with slits is placed via an insulating film on planar electrodes each formed to occupy the corresponding pixel region.

In the present embodiment, a horizontal alignment mode display panel 10 is described in which the pixel electrodes and the common electrode are placed in one of the substrates, but the display mode of the display panel 10 is not limited thereto and may be in a vertical alignment mode in which the pixel electrodes are placed in the TFT substrate 120 and the common electrode is placed in the CF substrate 110. The horizontal alignment mode is a mode in which liquid crystal molecules are aligned in a direction substantially horizontal to the main surfaces of the pair of substrates during no voltage application to the liquid crystal layer. Examples of the horizontal alignment mode include the FFS mode described above and the in-plane switching (IPS) mode. The vertical alignment mode is a mode in which liquid crystal molecules are aligned in a direction substantially vertical to the main surfaces of the pair of substrates during no voltage application to the liquid crystal layer. Examples of the vertical alignment mode include the vertical alignment (VA) mode and the twisted nematic (TN) mode.

Alignment films having a function of controlling the alignment of liquid crystal molecules contained in the liquid crystal layer 130 are placed, one between the TFT substrate 120 and the liquid crystal layer 130 and the other between the CF substrate 110 and the liquid crystal layer 130. In the state with no voltage applied where voltage is not applied between the pixel electrodes and the common electrode, the liquid crystal molecules in the liquid crystal layer 130 are aligned substantially horizontally to the main surfaces of the pair of substrates.

The display panel 10 further includes a source driver electrically connected to the source lines, a gate driver electrically connected to the gate lines, and a controller. The gate driver sequentially supplies scanning signals to the gate lines based on the controller's control. When a TFT is switched according to a scanning signal to the state with voltage applied, the source driver supplies a data signal to the corresponding source line based on the controller's control. The pixel electrodes are each set at a potential corresponding to the data signal supplied via the corresponding TFT, so that a fringe electric field is generated between the pixel electrode and the common electrode to rotate the liquid crystal molecules in the liquid crystal layer. This is how the magnitude of voltage applied between a pixel electrode and the common electrode is controlled and the retardation provided by the liquid crystal layer is changed to control transmission or blocking of light.

The CF substrate 110 may be one commonly used in the field of liquid crystal display panels and may have a configuration in which, for example, components such as color filters and a black matrix (BM) layer are placed on the surface of a transparent substrate such as a glass substrate. Specifically, the CF substrate 110 includes, on an insulating substrate, a black matrix formed in a grid pattern correspondingly to the gate lines and the source lines, color filters of multiple colors, including red layers, green layers, and blue layers periodically placed in the grid cells of the black matrix, an overcoat layer made of a transparent insulating resin and covering the black matrix and the color filters, and columnar photospacers placed on the overcoat layer.

The pair of polarizing plates 50 and the adhesive layer 150 (e.g., OCA) are not limited and can be those used in an ordinary liquid crystal display device. The liquid crystal layer 130 can also be one usually used in an ordinary liquid crystal display device. Thus, description of these components is omitted.

### <Backlight>

The backlight 40 may be any backlight that emits light to the liquid crystal panel 20. For example, the backlight 40 may have a configuration including light sources and a reflective sheet. The light sources can be common backlight light sources, i.e., light sources such as cold cathode fluorescent lamps (CCFLs) and light emitting diodes (LEDs).

The backlight 40 may also be a direct-lit backlight or an edge-lit backlight. In the case of an edge-lit backlight, the backlight 40 may have a configuration including light sources, a reflective sheet, and a light guide plate. The light sources are placed on the end surface(s) of the light guide plate, and the reflective sheet is placed on the back surface of the light guide plate. The light guide plate can be one usually used in the field of video display devices. Examples of the reflective sheet include aluminum boards, white polyethylene terephthalate (PET) films, reflective films (e.g., enhanced specular reflector (ESR) film available from 3M Company).

### <Others>

The video display device 1 of the present embodiment including the above-described components also includes multiple components such as external circuits, e.g., tape carrier packages (TCPs) and printed circuit boards (PCBs); optical films, e.g., viewing angle increasing films and luminance enhancing films; and bezels (frames). Some components may be incorporated into another component. Components other than those already descried above are not limited and can be one usually used in the field of video display devices, and thus description thereof is omitted.

### Modified Example of Embodiment 1

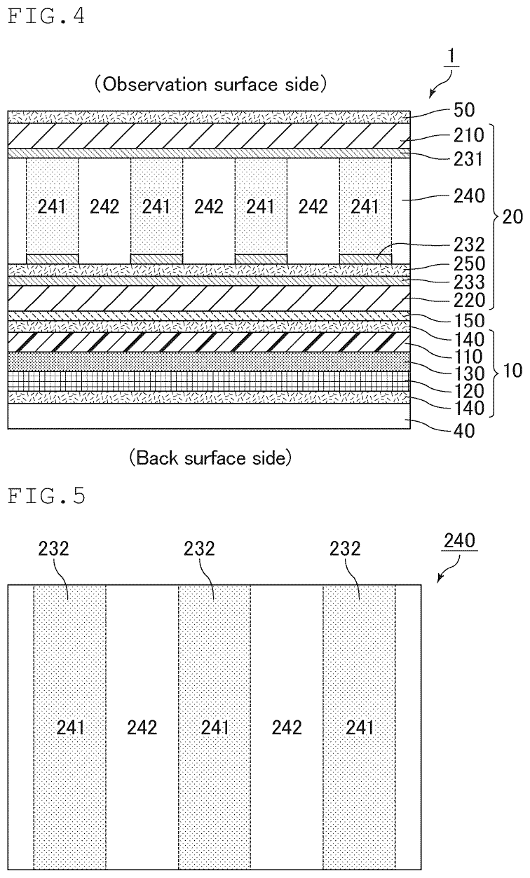

The video display device 1 of Embodiment 1 includes the display panel 10 on the observation surface side of the liquid crystal panel 20 but may include the display panel 10 on the back surface side of the liquid crystal panel 20. In other words, as shown in FIG. 4, the video display device 1 may have a configuration including the liquid crystal panel 20, the display panel 10, and the backlight 40 in order from the observation surface side toward the back surface side. FIG. 4 is a schematic cross-sectional view of a video display device of the present example.

### Embodiment 2

In the present embodiment, features unique to the present embodiment are mainly described and description of the same features as in Embodiment 1 is omitted. The present embodiment is substantially the same as Embodiment 1, except that the position of the second electrodes 232 and the design of the power supply are different in the liquid crystal panel 20.

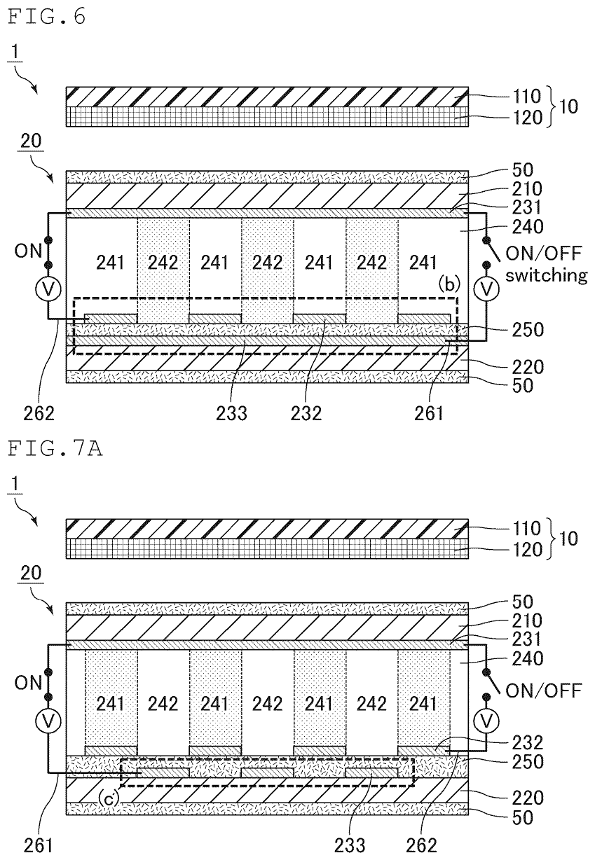

FIG. 6 is a schematic cross-sectional view of a video display device 1 of the present embodiment. As shown in FIG. 6, the video display device 1 of the present embodiment includes a liquid crystal panel 20 and a display panel 10 that displays images. The liquid crystal panel 20 includes a first transparent substrate 210, a first electrode 231, a liquid crystal layer 240, second electrodes 232, and a second transparent substrate 220 in the stated order, and further includes, between the second electrodes 232 and the second transparent substrate 220, an interlayer insulating film 250 and a third electrode 233 in order from the second electrode 232 side in the stated order. The pair of polarizing plates 50 is placed, one on the back surface side and the other on the observation surface side of the liquid crystal panel 20. This gives a structure in which the liquid crystal layer 240 is sandwiched between the pair of polarizing plates 50 (i.e., sandwiched structure).

The portion (b) in FIG. 6 is the site mainly different from the liquid crystal panel 20 in Embodiment 1 (see also FIG. 1). In Embodiment 1, the switching regions 243 are designed to be switchable between the high transmission state (see FIG. 2A) and the low transmission state (see FIG. 2B) in response to voltage application or no voltage application between the first electrode 231 and the second electrodes 232 (262). In contrast, in the present embodiment, the switching regions 243 are designed to be switchable between the high transmission state and the low transmission state in response to voltage application or no voltage application between the first electrode 231 and the third electrode 233 (261). In this case, in the present embodiment, the overlapping regions 241 serve as the transparent regions 244 and the non-overlapping regions 242 serve as the switching regions 243 (see FIG. 6). In practice, not only the non-overlapping regions 242 serve as the switching regions 243 but also the boundary between an overlapping region 241 and a non-overlapping region 242 may serve as a switching region 243 or a different portion may serve as a switching region 243, depending on the intensity of the electric field generated between the electrodes. Thus, as in Embodiment 1, the transparent regions 244 and the switching regions 243 are not limited to the mode shown in FIG. 6, and can appropriately be controlled by, for example, the width and pitch of the second electrodes 232, the cell thickness (i.e., thickness D of the non-overlapping regions 242), and voltage applied to the electrodes. Similar considerations apply to the following other embodiments.

### Embodiment 3

In the present embodiment, features unique to the present embodiment are mainly described and description of the same features as in Embodiment 1 is omitted. The present embodiment is substantially the same as Embodiment 1, except that arrangement of the third electrode 233 in the liquid crystal panel 20 is different.

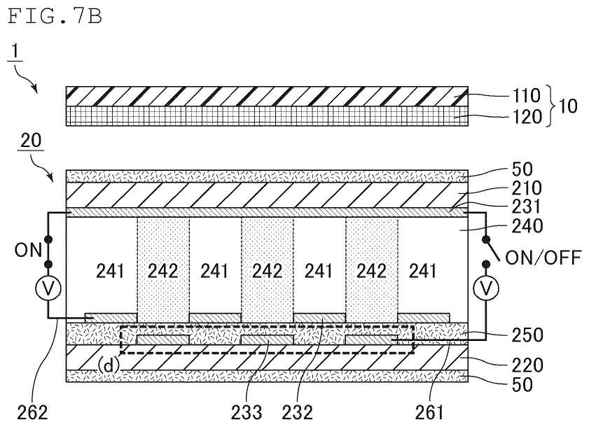

FIG. 7A is a schematic cross-sectional view of a video display device of the present embodiment. As shown in FIG. 7A, a video display device 1 includes a liquid crystal panel 20 and a display panel 10 that displays images. The liquid crystal panel 20 includes a first transparent substrate 210, a first electrode 231, a liquid crystal layer 240, second electrodes 232, and a second transparent substrate 220 in the stated order, and further includes, between the second electrodes 232 and the second transparent substrate 220, an interlayer insulating film 250 and a third electrode 233 in the stated order from the second electrode 232 side.

The portion (c) in FIG. 7A is a site mainly different from the liquid crystal panel 20 in Embodiment 1 (see also FIG. 1). In Embodiment 1, the third electrode 233 is a planar electrode placed on the entire surface of the second transparent substrate 220. In other words, the third electrode 233 is what is called a solid electrode. In contrast, in the present embodiment, the third electrode 233 is formed by patterning.

### Modified Example of Embodiment 3

In a liquid crystal panel 20 in Embodiment 3, the switching regions 243 are designed to be switchable between the high transmission state and the low transmission state in response to voltage application or no voltage application between the first electrode 231 and the second electrodes 232 (262) (see FIG. 7A). This design may be changed to a design as in Embodiment 2 where the switching regions 243 are switchable between the high transmission state and the low transmission state in response to voltage application or no voltage application between the first electrode 231 and the third electrode 233 (261) (see FIG. 7B). In the present example, this design (see FIG. 7B) makes the overlapping regions 241 serve as the transparent regions 244 and the non-overlapping regions 242 serve as the switching regions 243. Yet, as described above, in practice, not only the non-overlapping regions 242 serve as the switching regions 243 but also the boundary between an overlapping region 241 and a non-overlapping region 242 may serve as a switching region 243 or a different portion may serve as a switching region 243, depending on the intensity of the electric field generated between the electrodes.

The portion (d) in FIG. 7B is a site mainly different from the liquid crystal panel 20 in Embodiment 2 (see also FIG. 6). In Embodiment 2, the third electrode 233 is a planar electrode placed on the entire surface of the second transparent substrate 220 as in Embodiment 1. In other words, the third electrode 233 is what is called a solid electrode. In contrast, in the present embodiment, the third electrode 233 is formed by patterning.

### Embodiment 4

In the present embodiment, features unique to the present embodiment are mainly described and description of the same features as in Embodiment 1 is omitted. The present embodiment is substantially the same as Embodiment 1, except that the second electrodes 232 in the liquid crystal panel 20 are electrodes containing a light-absorbing material.

FIG. 8A is a schematic cross-sectional view showing a wide viewing angle mode of a video display device 1 of the present embodiment. FIG. 8B is a schematic cross-sectional view showing a narrow viewing angle mode of the video display device 1 of the present embodiment. As shown in FIG. 8A and FIG. 8B, the video display device 1 includes a liquid crystal panel 20 and a display panel 10 that displays images, and further includes a backlight 40.

The liquid crystal panel 20 includes a first transparent substrate 210, a first electrode 231, a liquid crystal layer 240, second electrodes 232, and a second transparent substrate 220 in the stated order, and further includes, between the second electrodes 232 and the second transparent substrate 220, an interlayer insulating film 250 and a third electrode 233 in the stated order from the second electrode 232 side. A pair of polarizing plates 50 is placed, one on the back surface side and the other on the observation surface side of the liquid crystal panel 20. This gives a structure in which the liquid crystal layer 240 is sandwiched between the pair of polarizing plates 50.

In the present embodiment, the second electrodes 232 in the liquid crystal panel 20 are electrodes containing a light-absorbing material. Use of electrodes containing a light-absorbing material can reduce oblique emission light (which specifically means light emitted as light traveling in an oblique direction from the liquid crystal panel 20), thus further enhancing the narrow viewing angle performance. The electrodes containing a light-absorbing material are preferably, for example, light-absorbing material electrodes, stacks of a light-absorbing material layer and a transparent electrode, stacks of a reflective material and a light-absorbing material electrode, or stacks of a reflective material, a light-absorbing material layer, and a transparent electrode.

The light-absorbing material, the transparent electrode, and the reflective material constituting an electrode containing a light-absorbing material may be those usually used in the field of electrodes.

Examples of the light-absorbing material include a metal black matrix (also referred to as a metal BM) made of metal and a resin black matrix (also referred to as a resin BM) made of a resin material. Examples of the metal BM include metal films containing aluminum, molybdenum, chromium, titanium, or an alloy of any of these metals. The metal BM may be a single-layer film or a multilayer film. Examples of the resin BM include black resists, with black photosensitive resins being preferred. Specific examples include black photosensitive acrylic resins. The transmittance of the light-absorbing material is preferably 0% or higher and 18 or lower, for example.

Examples of the transparent electrode are as mentioned above. In particular, ITO is preferred.

Examples of the reflective material include highly reflective metals such as silver, aluminum, alumina, talc, titanium, or an alloy of silver, palladium, and copper (APC). Also, a dielectric multilayer film (reflection enhancing film) in which a high-refractive-index layer such as a Ta-03 layer and a low-refractive-index layer such as a MgF-layer are stacked, or a stack of a highly reflective metal and a reflection enhancing film can be used. The reflective material can be formed by, for example, forming a metal film by vapor deposition, sputtering, or another method, and then patterning the metal film. The light reflectance of the reflective material is preferably, for example, 90% or higher and 100% or lower.

In the present embodiment, a case where the second electrodes 232 are light-absorbing material electrodes is particularly described. The light-absorbing material electrodes are preferably a metal BM. A metal BM is usually formed as a finely patterned metal thin film on a substrate. Examples of the material of the metal thin film include aluminum, molybdenum, chromium, titanium, and alloys of any of these metals. The film is commonly formed by vapor deposition, sputtering, or vacuum film formation, for example. The metal thin film is patterned by, for example, applying a photoresist to a metal thin film, drying the photoresist, irradiating the photoresist with ultraviolet light through a photomask, dissolving the unexposed portion with a developer to form a resist pattern, and etching the metal and/or peeling off the resist.

In the narrow viewing angle mode of the liquid crystal panel 20 in Embodiment 1 (see FIG. 2B), light directly enters the switching regions 243 (low transmission state) from the backlight 40 (see the portion (a) in FIG. 2B) and is blocked by the switching regions 243. In the narrow viewing angle mode in the present embodiment (see FIG. 8B), light directly enters the switching regions 243 (low transmission state) from the backlight 40 (see the portion (f) in FIG. 8B) and is cut by the light-absorbing material electrodes (second electrodes 232), so that light emitted from the liquid crystal panel 20 can be further reduced. Thus, in the present embodiment, the narrow viewing angle performance is further enhanced as compared to that in Embodiment 1.

Even in the narrow viewing angle mode in the present embodiment, a slight amount of light is emitted obliquely because there is light that does not directly enter the switching regions 243 from the backlight 40 but enters the switching regions 243 through the transparent regions 244 (i.e., light that enters the switching regions 243 from the backlight 40 without passing through the light-absorbing material electrodes (second electrodes 232)).

### Modified example of Embodiment 4

In Embodiment 4, the case is described where the second electrodes 232 in the liquid crystal panel 20 are electrodes containing a light-absorbing material, in particular, light-absorbing material electrodes. Yet, the second electrodes 232 can also be a stack of a light-absorbing material layer and a transparent electrode. Also in this case, as in Embodiment 4, the narrow viewing angle performance is further enhanced as compared to that in Embodiment 1.

The light-absorbing material layer is preferably a resin BM. Specific examples of the stack of a light-absorbing material layer and a transparent electrode include a stack including a transparent electrode (e.g., ITO) on a resin BM.

### Embodiment 5

In the present embodiment, features unique to the present embodiment are mainly described and description of the same features as in Embodiment 1 is omitted. The present embodiment is substantially the same as Embodiment 1, except that the second electrodes 232 in the liquid crystal panel 20 are electrodes containing a light-absorbing material.

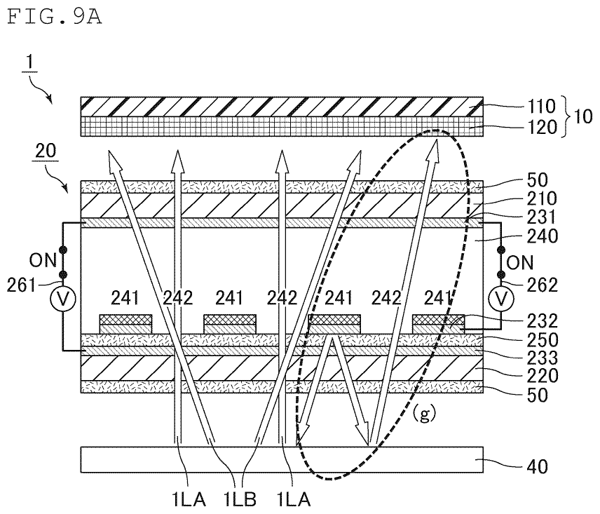

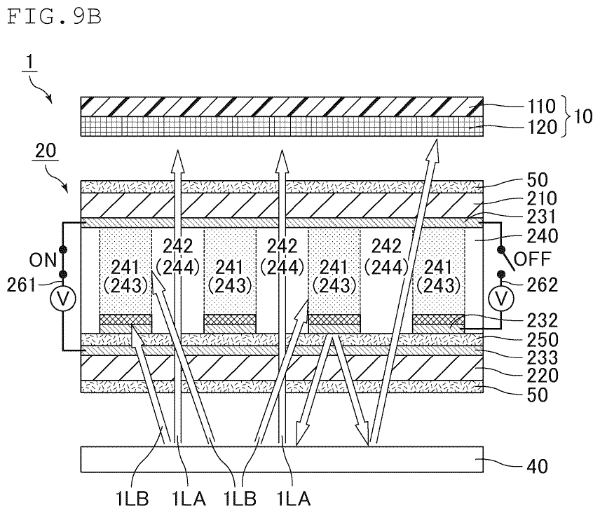

FIG. 9A is a schematic cross-sectional view showing a wide viewing angle mode of a video display device 1 of the present embodiment. FIG. 9B is a schematic cross-sectional view showing a narrow viewing angle mode of the video display device 1 of the present embodiment. As shown in FIG. 9A and FIG. 9B, the video display device 1 includes a liquid crystal panel 20 and a display panel 10 that displays images, and further includes a backlight 40.

The liquid crystal panel 20 includes a first transparent substrate 210, a first electrode 231, a liquid crystal layer 240, second electrodes 232, and a second transparent substrate 220 in the stated order, and further includes, between the second electrodes 232 and the second transparent substrate 220, an interlayer insulating film 250 and a third electrode 233 in the stated order from the second electrode 232 side. A pair of polarizing plates 50 is placed, one on the back surface side and the other on the observation surface side of the liquid crystal panel 20. This gives a structure in which the liquid crystal layer 240 is sandwiched between the pair of polarizing plates 50.

In the present embodiment, the second electrodes 232 in the liquid crystal panel 20 are electrodes containing a light-absorbing material. Use of electrodes containing a light-absorbing material can reduce oblique emission light, thus further enhancing the narrow viewing angle performance. In the present embodiment, a case is described where electrodes containing a light-absorbing material, in particular, stacks of a reflective material and a light-absorbing material electrode, are used as the second electrodes 232.

The reflective material preferred among the metals described above is silver (Ag), for example. The light-absorbing material electrode is preferably a metal BM as described above. Thus, the stacks of a reflective material and a light-absorbing material electrode are suitably stacks including a metal BM on silver. When the second electrodes 232 are electrodes containing a reflective material, the reflective material is preferably positioned on the backlight 40 side. In other words, when stacks of a reflective material and a light-absorbing material electrode are used, the stacks are suitably placed with the reflective material being on the backlight 40 side.

As in Embodiment 4, in the present embodiment, the narrow viewing angle performance is further enhanced as compared to that in Embodiment 1. In Embodiment 4, however, there is a trade-off with enhancement of the narrow viewing angle performance; light may be cut by the second electrodes 232 (light-absorbing material electrodes) in the wide viewing angle mode in which light 1LB traveling in an oblique direction needs not to be cut (see the portion (e) in FIG. 8A). In contrast, since the second electrodes 232 (stacks of a reflective material and a light-absorbing material electrode) contains a reflective material in the present embodiment, the reflective material can reflect light incident on the overlapping regions 241 (switching regions 243 in the low transmission state) from the backlight 40 toward the back surface side (backlight 40 side). In addition, when the backlight 40 includes a reflective sheet, light reflected by the reflective material is reflected again by the reflective sheet toward the observation surface side to be recycled as light that enters the non-overlapping regions 242 (transparent regions 244) (see the portion (g) in FIG. 9A). As a result, light directly entering the overlapping regions 241 (switching regions 243 in the low transmission state), which is desired to be cut in the narrow viewing angle mode, is cut and can be changed to (recycled as) light traveling in a front direction without being wasted. Thus, in the present embodiment, the luminance can be increased both in the wide viewing angle mode and the narrow viewing angle mode.

### Modified example of Embodiment 5

In Embodiment 5, the second electrodes 232 in the liquid crystal panel 20 are stacks of a reflective material and a light-absorbing material electrode among electrodes containing a light-absorbing material. Yet, the second electrodes 232 can also be stacks of a reflective material, a light-absorbing material layer, and a transparent electrode. Also in the present modified example, as in Embodiment 5, the narrow viewing angle performance is further enhanced, and the luminance can be increased in both the wide viewing angle mode and the narrow viewing angle mode owing to the second electrode 232 containing a reflective material.

The reflective material is preferably silver (Ag) as described above. The light-absorbing material layer is preferably a resin BM as described above. Thus, the stacks of a reflective material, a light-absorbing material layer, and a transparent electrode are suitably stacks including a resin BM and a transparent electrode (e.g., ITO) on silver. Also in this case, the stacks are suitably placed with the reflective material being on the backlight 40 side.

### Embodiment 6

In the present embodiment, features unique to the present embodiment are mainly described and description of the same features as in Embodiment 1 is omitted. The present embodiment is substantially the same as Embodiment 1, except that the backlight 40 is a backlight with local dimming.

FIG. 1, FIG. 2A, and FIG. 2B are respectively a schematic cross-sectional view of a video display device of the present embodiment, a schematic cross-sectional view showing the wide viewing angle mode of the video display device of the present embodiment, and a schematic cross-sectional view showing the narrow viewing angle mode of the video display device of the present embodiment. In the present embodiment, the backlight 40 is a backlight with local dimming.

The local dimming is a function of dividing the image display region of the display device into multiple areas (also called segments) and controlling light for each area. A backlight with local dimming allows the backlight luminance to be controlled locally, thus increasing the contrast ratio of the display device and reducing the power consumption. Generally, however, controlling the viewing angle during operation with local dimming is difficult for a display device that controls the viewing angle using its backlight. In contrast, the present invention, utilizing the liquid crystal panel 20 to control the viewing angle, can employ any backlight driving technology. Thus, the liquid crystal panel 20 can be used in combination with a backlight with local dimming, which is very useful.

### Embodiment 7

In the present embodiment, features unique to the present embodiment are mainly described and description of the same features as in Embodiment 1 is omitted. The present embodiment is substantially the same as Embodiment 1, except that the display panel 10 is a self-luminous display panel.

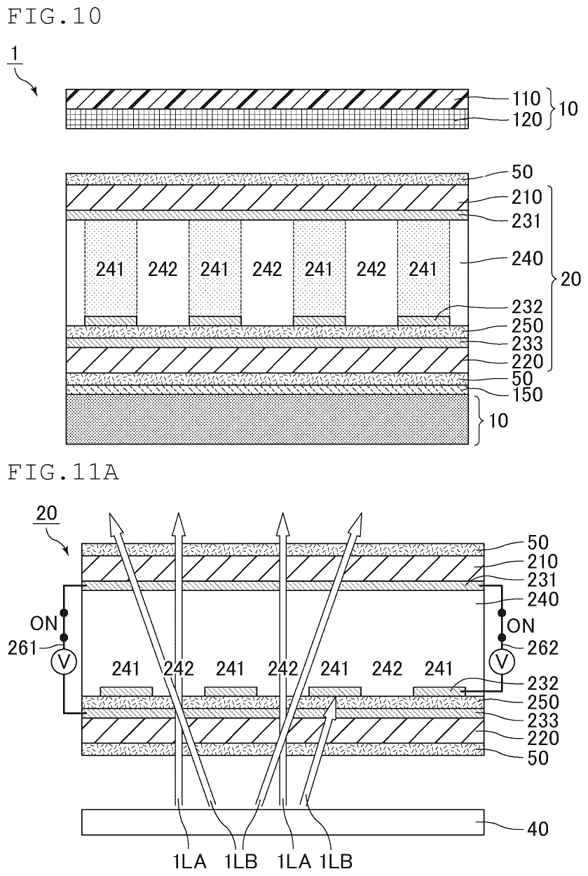

FIG. 10 is a schematic cross-sectional view of a video display device of the present embodiment. As shown in FIG. 10, a video display device 1 of the present embodiment includes a liquid crystal panel 20 and a self-luminous display panel serving as a display panel 10 that displays images. The video display device 1 usually includes an adhesive layer 150 between the display panel 10 and the liquid crystal panel 20 to attach the display panel 10 and the liquid crystal panel 20 to each other. Since the video display device of the present embodiment includes the self-luminous display panel as the display panel 10, no backlight is required.

The self-luminous display panel may be any self-luminous-type display panel. Examples include organic electroluminescent (EL) display panels and micro-LED-type display panels using fine micrometer (μm)-scale LEDs as RGB elements. In the present invention, the viewing angle can be controlled by the liquid crystal panel 20 regardless of whether the backlight is included or not. Thus, the liquid crystal panel 20 can be combined with a self-luminous display panel, which is very useful.

Embodiments of the present invention are described above, and all the individual matters described are applicable to the general aspects of the present invention.

### EXAMPLES

The present invention is described in more detail below based on examples. The present invention is not limited to these examples.

### Example 1

A video display device of Example 1 corresponds to the video display device of Embodiment 1 (see FIG. 1, FIG. 2A, FIG. 2B, and FIG. 5). The display panel 10 is designed to have a size of 11 inch, a resolution of FHD, and a pixel pitch (pixel width in extension direction of gate lines×pixel width in extension direction of source lines) of 42 μm×126 μm. Table 1 shows the design values of the liquid crystal panel 20.

In the examples described below, the display panel 10 and the backlight 40 are the same ones as those used in Example 1, unless otherwise specified. The designs and structures of the liquid crystal panel 20 are also the same as those in Example 1, unless otherwise specified.

TABLE 1

| | | Example 1 |
|---|---|---|
| Display panel 10 | Size | 11 inch |
| | Resolution | FHD |
| | Pixel pitch [μm] | 42 × 126 |
| Liquid crystal | Viewing angle θ [°] | 33 |
| panel 20 | Width W1 of non-overlapping regions | 3 |
| | [μm] | |
| | Width 2 of overlapping regions [μm] | 3 |
| | Pitch of non-overlapping regions [μm] | 6 |
| | Height D of non-overlapping regions [μm] | 10 |

In the present example, the first electrode 231 functions as a common electrode, the first electrode 231 and the third electrode 233 control the non-overlapping regions 242 (mainly the transparent regions 244), and the first electrode 231 and the second electrodes 232 control the overlapping regions 241 (mainly the switching regions 243).

The video display device of the present example can be compatible with the ordinary liquid crystal process, causes no moire, and exhibits excellent viewing angle performance. In particular, the video display device can achieve the wide viewing angle mode with high luminance and can also prevent an increase in thickness, weight, and manufacturing costs of the video display device.

### Example 2

A video display device of Example 2 also corresponds to the video display device of Embodiment 1. In the present example, the liquid crystal panel 20 was designed to operate in a liquid crystal mode of the vertical alignment VA mode and include negative liquid crystal molecules to define the liquid crystal layer 240. The pair of polarizing plates 50 between which the liquid crystal layer 240 was sandwiched was arranged in crossed Nicols. FIG. 11A is a schematic cross-sectional view showing a wide viewing angle mode of a video display device of the present example. FIG. 11B is a schematic cross-sectional view showing a narrow viewing angle mode of the video display device of the present example. In FIG. 11A and FIG. 11B, the display panel 10 is omitted for convenience.

As shown in FIG. 11A and FIG. 11B, light enters the liquid crystal panel 20 from the back surface side (specifically, backlight 40). In a state where voltage is applied between the first electrode 231 and the second electrodes 232 (262) and voltage is applied between the first electrode 231 and the third electrode 233 (261) (state with voltage applied), the overlapping regions 241 and the non-overlapping regions 242 are integrated with no distinction, the entire liquid crystal layer 240 is in the high transmission state (i.e., constitutes a transparent region) (see FIG. 11A). In other words, the transparent regions 244 and the switching regions 243 have a transmittance T1. In this case, lights having entered the liquid crystal panel 20 from the backlight 40, including both light traveling in a front direction and light traveling in an oblique direction, are transmitted through the liquid crystal panel 20 as they are (see FIG. 11A). As a result, in a region ranging from low to high polar angles, light from the back surface side (specifically, backlight 40) can be transmitted without any loss, so that the wide viewing angle mode is achieved with high luminance.

In a state where no volage is applied between the first electrode 231 and the second electrodes 232 (262) and voltage is applied between the first electrode 231 and the third electrode 233 (261) (state with no voltage applied), the liquid crystal layer 240 itself acts as a louver. In other words, light 1LB traveling in an oblique direction entering the liquid crystal layer 240 from the backlight 40 is blocked by the overlapping regions 241 (switching regions 243). Thus, the overlapping regions 241 (switching regions 243) are in the low transmission state, whereas the non-overlapping regions 242 (transparent regions 244) remain in the high transmission state. In other words, the transparent regions 244 have a transmittance T2 and the switching regions 243 have a transmittance T3 (where T1>T2>T3). Light 1LA traveling in a front direction entering the liquid crystal layer 240 from the backlight 40 is transmitted through the liquid crystal panel 20 without being attenuated (see FIG. 11B). As a result, light from the back surface side (specifically, backlight 40) is attenuated at high polar angles, and light from the back surface side can be transmitted with the same luminance only at low polar angles, so that the narrow viewing angle mode can be achieved.

FIG. 12A shows waveform diagrams of voltages of electrodes in the wide viewing angle mode in the video display device of the present example (see FIG. 11A). FIG. 12B shows waveform diagrams of voltages of electrodes in the narrow viewing angle mode in the video display device of the present example (see FIG. 11B). The waveform diagram I (231) is of voltage of the first electrode 231. The waveform diagram II (232) is of voltage of the second electrodes 232. The waveform diagram III (233) is of voltage of the third electrode 233. The horizontal axis represents time. The vertical axis represents voltage (V). The driving voltage is not limited to the present voltage settings, and may be set as appropriate.

In the present example, the first electrode 231 (I) functions as a common electrode, the first electrode 231 (I) and the third electrode 233 (III) control the non-overlapping regions 242 (mainly the transparent regions 244), and the first electrode 231 (I) and the second electrodes 232 (II) control the overlapping regions 241 (mainly the switching regions 243).

The video display device of the present example can also be compatible with the ordinary liquid crystal process, causes no moire, and exhibits excellent viewing angle performance. In particular, the video display device can achieve the wide viewing angle mode with high luminance and can also prevent an increase in thickness, weight, and manufacturing costs of the video display device.

### Example 3

A video display device of Example 3 corresponds to the video display device of Embodiment 2 (see FIG. 6). In the present example, the switching regions 243 are designed to be switchable between the high transmission state and the low transmission state in response to voltage application or no voltage application between the first electrode 231 and the third electrode 233 (261) in the liquid crystal panel 20. In the present example, the overlapping regions 241 mainly serve as the transparent regions 244 and the non-overlapping regions 242 mainly serve as the switching regions 243.

### Examples 4-1 and 4-2

A video display device of Example 4-1 corresponds to the video display device of Embodiment 3 (see FIG. 7A). A video display device of Example 4-2 corresponds to the video display device of the modified example of Embodiment 3 (see FIG. 7B). The third electrodes 233 are formed by patterning as shown in the portion (c) in FIG. 7A and the portion (d) in FIG. 7B.

The video display device of the present example can also be compatible with the ordinary liquid crystal process, causes no moire, and exhibits excellent viewing angle performance. In particular, the video display device can achieve the wide viewing angle mode with high luminance and can also prevent an increase in thickness, weight, and manufacturing costs of the video display device.

### Example 5

A video display device of Example 5 corresponds to the video display device of Embodiment 4 (see FIG. 8A and FIG. 8B). In the present example, the second electrodes 232 in the liquid crystal panel 20 are light-absorbing material electrodes (metal BM). In the present example, the narrow viewing angle performance is further enhanced as compared to that in Example 1.

### Example 6

A video display device of Example 6 corresponds to the video display device of Embodiment 5 (see FIG. 9A and FIG. 9B). In the present example, the second electrodes 232 in the liquid crystal panel 20 are stacks of a reflective material and a light-absorbing material electrode. In the present example, the luminance in both the wide viewing angle mode and the narrow viewing angle mode is further increased as compared to that in Example 1.

### Example 7

A video display device of Example 7 corresponds to the video display device of Embodiment 6. FIG. 1, FIG. 2A, FIG. 2B, and FIG. 5 are to be referenced for the structure of the video display device, the traveling direction of light in each viewing angle mode, and other conditions. Even when the backlight with local dimming is used in combination as in the present example, a video display device exhibiting excellent viewing angle performance can be achieved while an increase in the thickness, weight, and manufacturing costs is prevented.

### Example 8

A video display device of Example 8 corresponds to the video display device of Embodiment 7 (see FIG. 10). Even when a self-luminous display panel is used in combination as in the present example, a video display device exhibiting excellent viewing angle performance can be achieved while an increase in the thickness, weight, and manufacturing costs is prevented.

The embodiments of the present invention described above may be combined as appropriate within the range not departing from the gist of the present invention.

### REFERENCE SIGNS LIST

1, 1R: video display device
1LA: light traveling in front direction
1LB: light traveling in oblique direction
10: display panel
20, 20R: liquid crystal panel
30R: louver layer
40: backlight
50: polarizing plate
110: color filter (CF) substrate
120: thin-film transistor (TFT) substrate
130: liquid crystal layer
150: adhesive layer
210: first transparent substrate
220: second transparent substrate
230: electrode
231: first electrode
232: second electrode
233: third electrode
240, 240R: liquid crystal layer
241: overlapping region
242: non-overlapping region
243: switching region
244: transparent region
250: interlayer insulating film
260, 261, 262: power supply

What is claimed is:

1. A video display device comprising:
a liquid crystal panel; and
a display panel configured to display an image,
the liquid crystal panel including a first transparent substrate, a first electrode, a liquid crystal layer, a second electrode, an interlayer insulating film, a third electrode, and a second transparent substrate in the stated order,
the liquid crystal layer including an overlapping region overlapping the second electrode and a non-overlapping region not overlapping the second electrode, and thus including a transparent region in a high transmission state and a switching region switchable between a high transmission state and a low transmission state,
the liquid crystal layer being sandwiched between a pair of polarizing plates.

2. The video display device according to claim 1,
wherein the video display device is capable of applying different voltages to the transparent region and the switching region, respectively.

3. The video display device according to claim 1,
wherein a thickness of the non-overlapping region is 30 μm or smaller.

4. The video display device according to claim 1,
wherein the second electrode is a transparent electrode or an electrode containing a light-absorbing material.

5. The video display device according to claim 1, further comprising a backlight.

6. The video display device according to claim 5,
wherein the backlight has a local dimming function.

7. The video display device according to claim 1,
wherein the display panel is a liquid crystal display panel or a self-luminous display panel.

8. The video display device according to claim 2,
wherein a thickness of the non-overlapping region is 30 μm or smaller.

9. The video display device according to claim 2,
wherein the second electrode is a transparent electrode or an electrode containing a light-absorbing material.

10. The video display device according to claim 2, further comprising a backlight.

11. The video display device according to claim 10,
wherein the backlight has a local dimming function.

12. The video display device according to claim 8,
wherein the second electrode is a transparent electrode or an electrode containing a light-absorbing material.

13. The video display device according to claim 8, further comprising a backlight.

14. The video display device according to claim 13,
wherein the backlight has a local dimming function.

15. The video display device according to claim 12, further comprising a backlight.

16. The video display device according to claim 15,
wherein the backlight has a local dimming function.
